(19) United States
(12) Patent Application Publication
(10) Pub. No.: US 2025/0144759 A1
(43) Pub. Date: May 8, 2025

(54) MACHINE TOOL, MACHINE TOOL CONTROL SYSTEM, AND MACHINE TOOL CONTROL METHOD

(71) Applicants: The University of Tokyo, Tokyo (JP); DMG MORI CO., LTD, Nara (JP)

(72) Inventors: Hiroshi FUJIMOTO, Tokyo (JP); Takumi HAYASHI, Tokyo (JP); Yuki TERADA, Nara (JP); Yoshihiro ISAOKA, Nara (JP)

(73) Assignees: The University of Tokyo, Tokyo (JP); DMG MORI CO., LTD, Nara (JP)

(21) Appl. No.: 18/833,382

(22) PCT Filed: Dec. 27, 2022
(86) PCT No.: PCT/JP2022/048116

§ 371 Date: Jul. 25, 2024

(30) Foreign Application Priority Data
Jan. 27, 2022 (JP) 2022-011321

(51) Int. Cl. B23Q 5/12

(52) U.S. Cl. CPC B23Q 5/12

(57) ABSTRACT

To accurately perform movement control of a moving body, a machine tool includes a feed driver that moves a moving body in the machine tool, a feedback controller that feedback-controls the feed driver in accordance with a state variable, a friction compensator that, to compensate for rolling friction that occurs in the feed driver, adds, in advance, a friction compensation value obtained from measurement data of rolling friction or a friction compensation value calculated using a rolling friction model to a command value to be input to the feed driver, and a reverse response reducer that reduces, using the state variable of the feedback controller, a reverse response that occurs due to addition of the friction compensation value.

### TECHNICAL FIELD

The present invention relates to a machine tool, a machine tool control system, and a machine tool control method.

### BACKGROUND ART

In the above technical field, patent literature 1 discloses a technique of estimating a frictional force and controlling movement of an object.

### CITATION LIST

### Patent Literature

Patent literature 1: Japanese Patent No. 5560068

### SUMMARY OF THE INVENTION

### Technical Problem

However, in the technique described in the above literature, in some cases, a reverse response is generated by friction compensation, and the object moving accuracy is low.

The present invention enables to provide a technique of solving the above-described problem.

### Solution to Problem

One example aspect of the invention provides a machine tool comprising:
a feed driver that moves a moving body in the machine tool;
a feedback controller that feedback-controls the feed driver in accordance with a state variable;
a friction compensator that, to compensate for rolling friction that occurs in the feed driver, adds, in advance, one of a friction compensation value obtained from measurement data of rolling friction and a friction compensation value calculated using a rolling friction model to a command value to be input to the feed driver; and
a reverse response reducer that reduces, using the state variable of the feedback controller, a reverse response that occurs due to addition of the friction compensation value.

Another example aspect of the invention provides a machine tool control system comprising:
a feedback controller that feedback-controls, in accordance with a state variable, a feed driver that moves a moving body in a machine tool;
a friction compensator that, to compensate for rolling friction that occurs in the feed driver, adds, in advance, one of a friction compensation value obtained from measurement data of rolling friction and a friction compensation value calculated using a rolling friction model to a command value to be input to the feed driver; and
a reverse response reducer that reduces, using the state variable of the feedback controller, a reverse response that occurs due to addition of the friction compensation value.

Still other example aspect of the invention provides a machine tool control method comprising:
feedback-controlling, in accordance with a state variable, a feed driver that moves a moving body in a machine tool;
to compensate for rolling friction that occurs in the feed driver, adding, in advance, one of a friction compensation value obtained from measurement data of rolling friction and a friction compensation value calculated using a rolling friction model to a command value to be input to the feed driver; and
reducing, using the state variable in the feedback-controlling, a reverse response that occurs due to addition of the friction compensation value.

### Advantageous Effects of Invention

According to the present invention, it is possible to accurately perform movement control of a moving body.

### BRIEF DESCRIPTION OF DRAWINGS

FIG. 1 is a block diagram showing the configuration of a machine tool according to the first example embodiment;

FIG. 2 is a block diagram showing the hardware configuration of a machine tool according to the second example embodiment;

FIG. 3 is a block diagram showing the functional configuration of the machine tool according to the second example embodiment;

FIG. 4 is a view for explaining a reverse quadrant glitch;

FIG. 5 is a block diagram showing the control system of the machine tool according to the second example embodiment;

FIG. 6 is a block diagram showing the control system of the machine tool according to the second example embodiment;

FIG. 7 is a block diagram showing the functional configuration of a machine tool according to the third example embodiment;

FIG. 8 is a block diagram showing the control system of the machine tool according to the third example embodiment;

FIG. 9 is a block diagram showing the control system of the machine tool according to the third example embodiment; and

FIG. 10 is a view showing an additional input value calculation method in the machine tool according to the third example embodiment.

### DESCRIPTION OF EXAMPLE EMBODIMENTS

Example embodiments of the present invention will now be described in detail with reference to the drawings. It should be noted that the relative arrangement of the components, the numerical expressions and numerical values set forth in these example embodiments do not limit the scope of the present invention unless it is specifically stated otherwise.

Note that in this specification, “reverse response” is a follow-up error (reverse quadrant glitch) in a direction reverse to a quadrant glitch that is a follow-up error at the time of speed reversal.

### First Example Embodiment

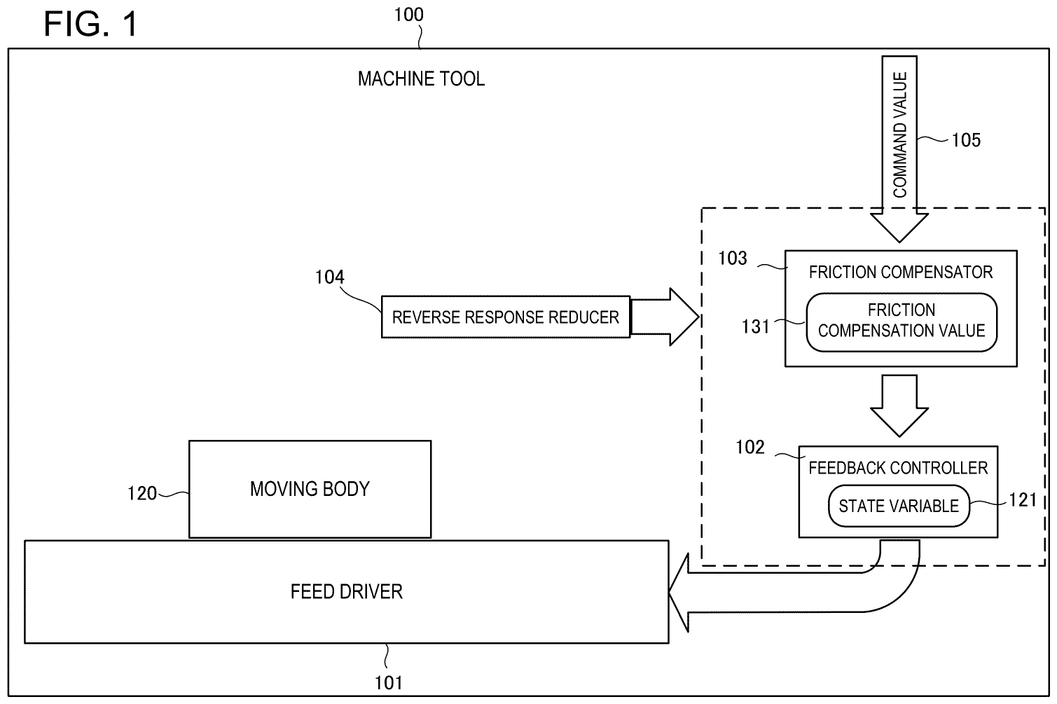

An object moving apparatus 100 according to the first example embodiment of the present invention will be described with reference to FIG. 1. The object moving apparatus 100 is an apparatus incorporated in a machine tool and configured to move a work placed on a stage.

As shown in FIG. 1, the machine tool 100 includes a feed driver 101, a feedback controller 102, a friction compensator 103, and a reverse response reducer 104.

The feed driver 101 moves a moving body 120 in the machine tool 100. The feedback controller 102 feedback-controls the feed driver 101 in accordance with an internal state variable 121.

To compensate for a rolling friction that occurs in the feed driver 101, the friction compensator 103 adds, to a command value 105 to the feed driver 101 in advance, a friction compensation value 131 obtained from the measurement data of the rolling friction or the friction compensation value 131 calculated using a rolling friction model.

The reverse response reducer 104 reduces a reverse response that occurs due to the addition of the friction compensation value using the state variable 121 of the feedback controller 102.

According to this example embodiment, it is possible to more accurately move the moving body by the above-described configuration.

### Second Example Embodiment

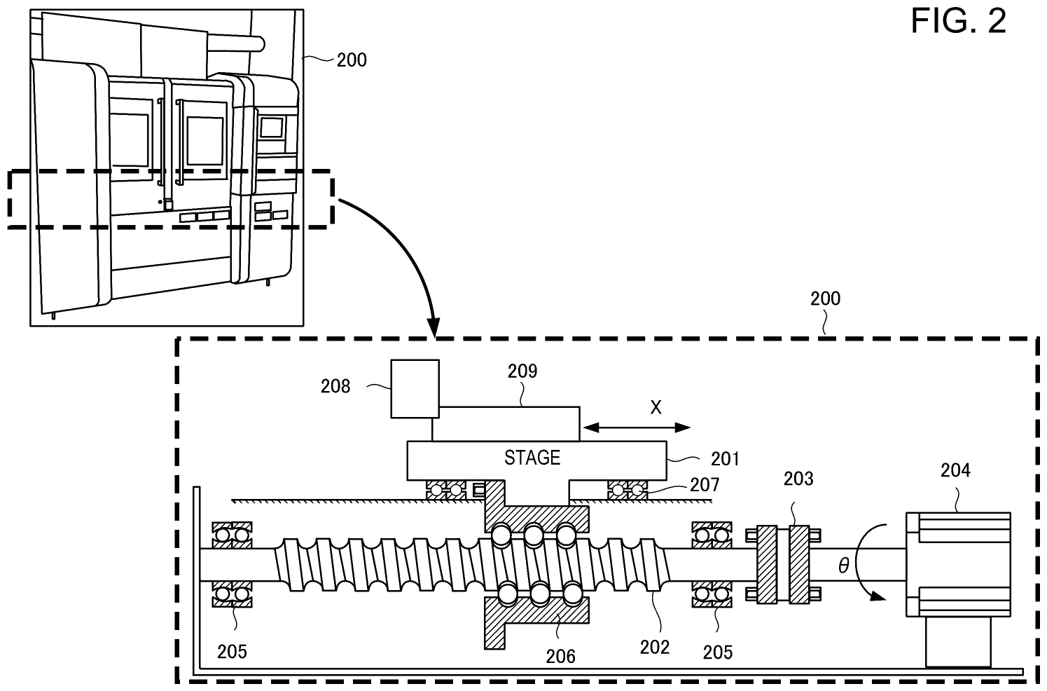

A machine tool 200 according to the second example embodiment of the present invention will be described next with reference to FIG. 2 and subsequent drawings. FIG. 2 is a view for explaining the configuration of the machine tool 200 according to this example embodiment. The machine tool 200 includes a ball screw 202 to move a stage 201 that is a moving body. Such a ball screw driven stage is often used as a feed device of an industrial machine such as a machine tool because of its high energy conversion efficiency, little wearing, and long life.

The ball screw 202 is connected to a motor 204 via a coupling 203 and also axially supported by bearings 205. Along with the rotation of the ball screw 202, a nut 206 moves in the left-and-right direction in FIG. 2, and the stage 201 thus moves in the X-axis direction while being guided by a linear guide 207.

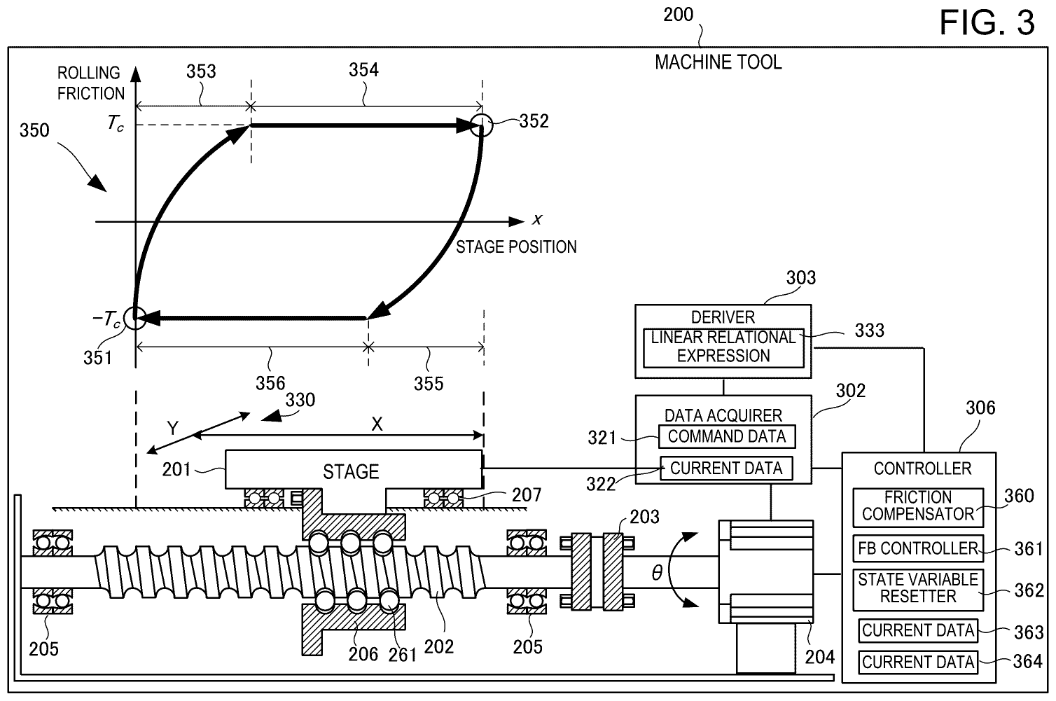

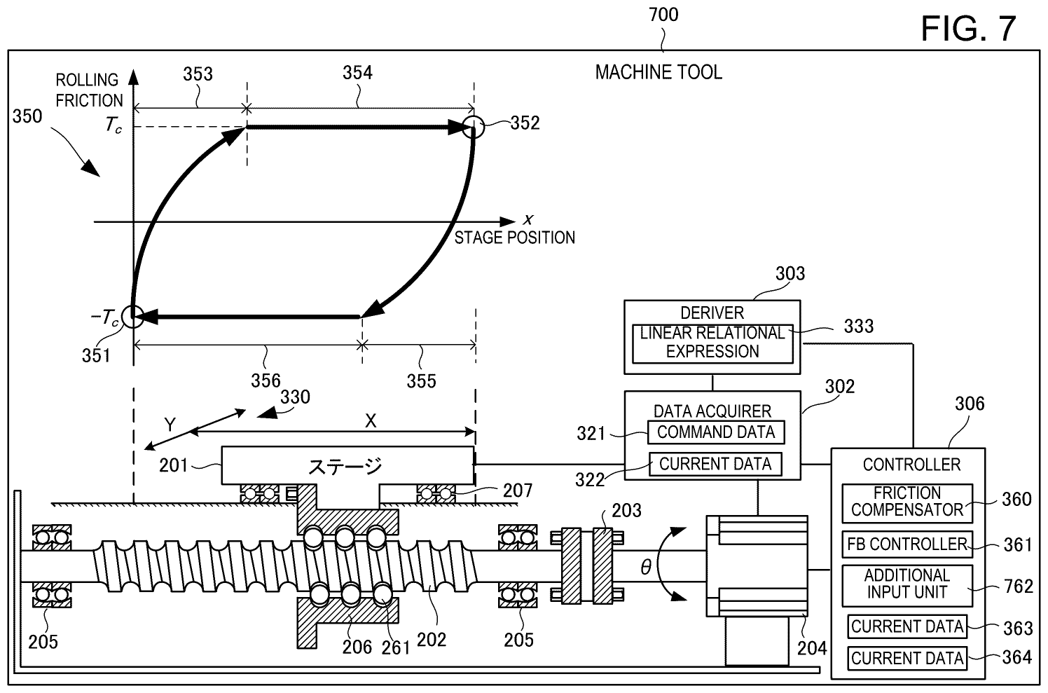

The units from the ball screw 202 to the linear guide 207 will collectively be referred to as a feed driver. This also applies to FIGS. 3 and 7.

The machine tool 200 includes a tool 208, and processes a work 209 that is a target processing object fixed on the stage 201. At this time, to improve processing quality and throughput, accurate stage drive control is required.

FIG. 3 is a view for explaining a configuration for drive control of the XY-axis ball screw driven stage 201 in the machine tool 200. The stage 201 reciprocally moves in the X- and Y-axis directions in a moving region 330. In this structure, the X-axis is placed on the Y-axis. The angle of the drive motor is measured by a rotary encoder with a resolution of 20 bits along both the X- and Y-axes, and the position of the stage is measured by a linear scale with a resolution of 1 nm. In this example embodiment, the purpose is to control the position of the stage while using the current of the drive motor of each axis as an input and the position of the stage of each axis as an output. Here, the X-axis and the Y-axis are independently controlled.

### (Frequency Characteristic)

Based on the frequency characteristic from a motor current u [A] to a stage position y [m], the control target of each axis is modeled by a rigid body, and its transfer function is defined as follows.

$$P ( s ) = R \cdot {K}_{T} / ( {Js}^{2} + {D}_{s} ) \qquad ( 1 )$$

where J is an equivalent inertia considering a stage weight, D is a viscous friction coefficient, R is the ratio of rotation and translation of the ball screw, and K_{T} is a torque constant.

In the ball screw driven stage 201, rolling friction lowers follow-up property. Rolling friction is caused by a ball 261 between the ball screw 202 and the nut 206 or a ball in the linear guide 207.

A graph 350 shows the relationship between the stage position and rolling friction of the ball screw. Rolling friction depends on a displacement from a speed reversing position. For example, the stage 201 starts moving from a start position 351, the speed is reversed at a speed reversing position 352, and the stage 201 returns to the original start position 351. In a region 353 until the stage 201 moves from the start position 351 by a predetermined distance, the rolling friction exhibits a nonlinear spring characteristic. On the other hand, in a region 354 up to the speed reversing position 352 after the stage 201 moves from the start position 351 by the predetermined distance, the rolling friction exhibits a constant value as a coulomb friction.

In a region 355 until the stage 201 moves by a predetermined distance after the speed is reversed at the speed reversing position 352, the rolling friction exhibits a nonlinear spring characteristic. After that, in a region 356 up to the start position 351, the rolling friction exhibits a constant value.

Due to the rolling friction, a large spike-like follow-up error called a quadrant glitch is generated near the speed reversing position. In the machine tool, the quadrant glitch causes excessive cutting or surface roughness of a work. Hence, the machine tool 200 compensates for the rolling friction, thereby suppressing the quadrant glitch.

As the rolling friction compensation method, a model base or learning base feedforward friction compensation approach is effective as compared to a feedback approach such as a disturbance observer.

A lot of rolling friction models such as a LuGre model, a generalized Maxwell-slip model, a rheology base model, a database friction model, and an elastoplastic base model have been proposed and evaluated so far. In the model base friction compensation approach, rolling friction is accurately measured, and a model is generated by curve fitting. Rolling friction is compensated for by a control input calculated based on the obtained model. On the other hand, in the learning base approach, for example, iterative learning control, instead of using a rolling friction model, a friction compensation input is gradually shaped during a plurality of times of movement control, thereby suppressing a quadrant glitch.

To compensate for rolling friction, the machine tool 200 includes a data acquirer 302, a deriver 303, and a controller 306.

The data acquirer 302 acquires command data 321 (displacement data rⱼ) indicating the displacement of the stage 201 and current data 322 (=f^{np}ⱼ₊₁) used to drive the motor 204.

The data acquirer 302 detects the speed reversing positions 352 and 351 based on a speed derived from the displacement data rⱼ, and determines, based on the displacement amounts from the speed reversing positions 351 and 352, whether the stage 201 exists in the linear regions 354 and 356 or the nonlinear regions 353 and 355.

Based on the current data 322 and the command data 321 in the linear regions 354 and 356, the deriver 303 estimates a linear relational expression 333 (=(f^{p}ⱼ₊₁=Ψ(rⱼ)θⱼ₊₁)) between a basis function Ψ(rⱼ) based on the command data 321 and the current data 322 (=f^{nP}ⱼ₊₁). θⱼ₊₁ in the linear relational expression 333 corresponds to the physical characteristic of the stage 201.

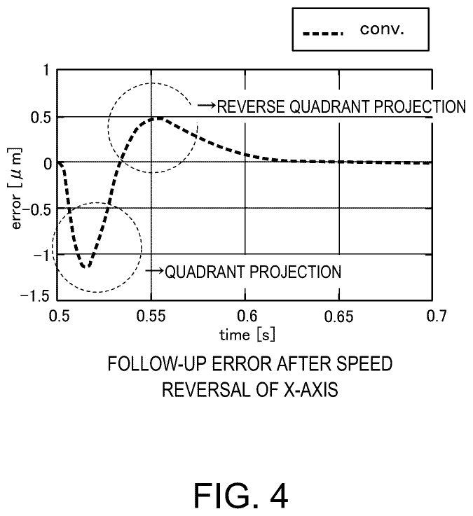

As described above, according to feedforward friction compensation, the follow-up error can effectively be reduced. However, as the result of friction compensation, a reverse response (reverse quadrant glitch) that is a follow-up error in a direction reverse to the quadrant glitch may be generated (FIG. 4). In cutting by the machine tool, the reverse response leads to overcutting (biting). The present applicant analyzed reverse responses by simulations and found that, if an equivalent input end disturbance caused by friction compensation was regarded as an impulse disturbance, a reverse quadrant glitch was generated by the impulse disturbance and the integrator of a feedback controller.

In a 2-degree-of-freedom control system that performs rolling friction compensation using a friction model, even if there is no modeling error, a reverse quadrant glitch is generated by a compensation error of rolling friction between sample points derived from 0th-order hold of control input and an integrator held by a feedback controller C.

However, an integrator is indispensable to suppress a steady-state error or a steady-state disturbance. In the industrial world, actually, a device including an integrator, such as a PID controller or a P-PI controller is widely used as a feedback controller.

Hence, a control system satisfying following requests (R1) to (R3) is demanded. (R1) To suppress a steady-state error or a steady-state disturbance, a feedback controller includes an integrator. (R2) A reverse quadrant glitch is suppressed without making a quadrant glitch large. (R3) The control system need not to be redesigned along with a change to the target track of the stage.

Hence, in this example embodiment, the controller 306 uses a PID controller as a feedback controller 361 as usual, and a state variable resetter 362 resets the state variable of the PID controller at a certain timing, thereby satisfying the above-described requests. That is, the state variable resetter 362 performs initial value compensation of resetting the state variable of the feedback controller 361.

The controller 306 calculates current data 363 for driving the motor 204 in the linear regions 354 and 356 using a basis function Ψ(rⱼ₊₁) based on command value track data rⱼ₊₁ of the next operation and the linear relational expression 333 (=(f^{p}ⱼ₊₁Ψ(rⱼ) θⱼ₊₁)) estimated by the deriver 303. Also, the controller 306 derives current data 364 for driving the motor 204 in the nonlinear regions 353 and 355 using the current data 322.

At this time, the controller 306 uses a friction model T\hat{ }rf as shown in the graph 350 to compensate for rolling friction by feedforward control of a friction compensator 360. A friction compensation value is calculated based on the friction model and the target position track of the stage.

Then, the controller 306 drives the motor 204 using the calculated current data 363 and the derived current data 364.

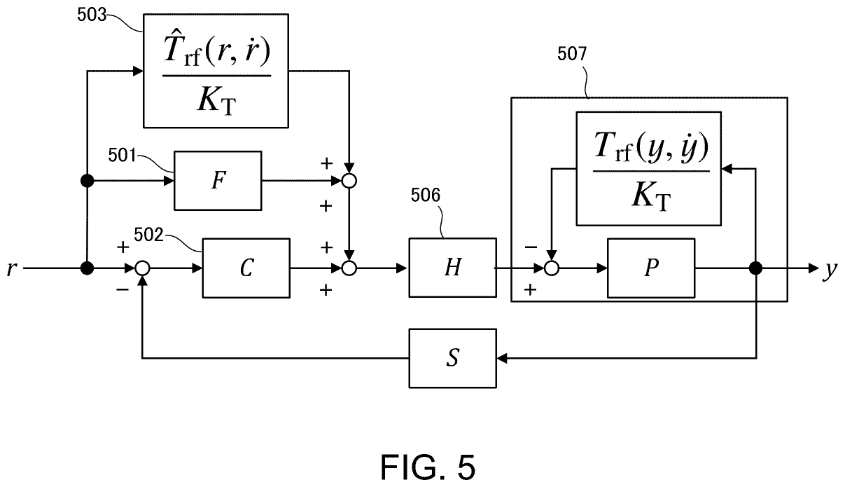

FIG. 5 is a view showing a typical 2-degree-of-freedom control system that performs rolling friction compensation using a friction model according to this example embodiment. The controller includes a feedforward controller 501 based on the reverse system of a characteristic P from the motor current to the stage position, a rolling friction compensator 503 using the model T\hat{ }rf of rolling friction Trf, and a feedback controller 502 configured to suppress a modeling error. The feedback controller 502 is a PID (Proportional-Integral-Derivative) controller including an integrator to suppress a steady-state error or a steady-state disturbance. A control target 507 indicates the feed driver and the stage.

$$C ( s ) = Kp + Ki ( 1 / s ) + Kd ( s / ( Tfs + 1 ) ) \qquad ( 2 )$$

where Kp is a proportional gain, Ki is an integral gain, Kd is a derivative gain, and Tf is a time constant of pseudo differential. All the four parameters have values larger than 0 and are designed to stabilize a closed loop system. A control input is discretized by a 0th-order hold 506 at a control period Ts. As an input end disturbance, rolling friction depending on the position and speed of the ball screw driven stage acts.

The control target P of this study represented by equation (1) is implemented by a controllable canonical system, thereby obtaining the following expressions, where d(t) is rolling friction that acts as the input end disturbance.

$$P \text{:} \{ \begin{matrix}{\dot{x}}_{p} ( t ) = {A}_{p} {x}_{p} ( t ) + {b}_{p} ( u ( t ) + d ( t ) ) \\ y ( t ) = {c}_{p} {x}_{p} ( t )\end{matrix} , \qquad ( 4 a )$$

$${A}_{p} = [ \begin{matrix}0 & 0 \\ 0 & - \frac{D}{J}\end{matrix} ] , \qquad ( 4 b )$$

$${b}_{p} = [ \begin{matrix}0 \\ \frac{{RK}_{T}}{J}\end{matrix} ] ,$$

$${c}_{p} = [ \begin{matrix}1 & 0\end{matrix} ] , \qquad ( 4 c )$$

$${x}_{p} = [ \begin{matrix}{x}_{p 1} \\ {x}_{p 2}\end{matrix} ] = [ \begin{matrix}y \\ \dot{y}\end{matrix} ] .$$

Also, the feedback controller (PID controller) C whose state variable is reset to x+c at time t=t+ is represented by

$$C \text{:} \{ \begin{matrix}{\dot{x}}_{c} ( t ) = {A}_{c} {x}_{c} ( t ) + {b}_{c} e ( t ) & if t \neq {t}^{+} \\ {x}_{c} ( t ) = {x}_{c}^{+} & if t = {t}^{+} \\ u ( t ) = {c}_{c} {x}_{c} + {d}_{c} e ( t ) & \end{matrix} , \qquad ( 5 a )$$

$${A}_{c} = [ \begin{matrix}0 & 0 \\ 0 & - \frac{1}{{T}_{f}}\end{matrix} ] , \qquad ( 5 b )$$

$${b}_{c} = [ \begin{matrix}{K}_{i} \\ - \frac{{K}_{d}}{{T}_{f}^{2}}\end{matrix} ] ,$$

$${c}_{c} = [ \begin{matrix}1 & 1\end{matrix} ] , \qquad ( 5 c )$$

$${d}_{c} = {K}_{p} + \frac{{K}_{d}}{{T}_{f}} ,$$

$${x}_{c} = [ \begin{matrix}{x}_{c 1} \\ {x}_{c 2}\end{matrix} ] .$$

Here, to derive the response of the feedback controller 502 after the reset of the state variable, the following assumptions (A1) to (A3) are made. (A1) In FIG. 5, follow-up performance to a target track r in the absence of a modeling error or a disturbance is guaranteed by the feedforward controller 501. (A2) In FIG. 5, a friction compensation error by the 0th-order hold 506 is regarded as an input end impulse disturbance applied at the time of speed reversal. (A3) Reset of the state variable of the feedback controller 502 is performed within a predetermined time after speed reversal.

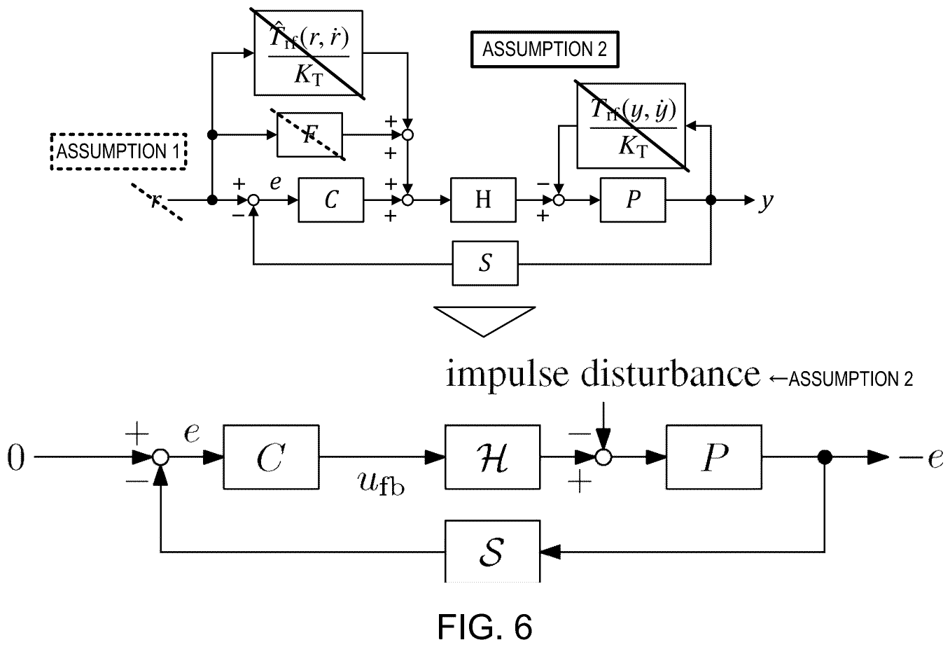

According to the assumptions (A1) and (A2), the control system shown in FIG. 5 is examined by simplifying as shown in FIG. 6. Also, according to the assumptions (A2) and (A3), since the disturbance can be neglected at the time t=t+ at which the state variable of the feedback controller 502 is reset, a closed loop system G at the time t≥t+ is represented, based on FIG. 5 and above-described expressions, by

$$G \text{:} \{ \begin{matrix}{\dot{x}}_{g} ( t ) = {A}_{g} {x}_{g} ( t ) \\ y ( t ) = - e ( t ) = {c}_{g} {x}_{g} ( t )\end{matrix} , \qquad ( 6 a )$$

$${A}_{g} = [ \begin{matrix}{A}_{p} - {b}_{p} {d}_{c} {c}_{p} & {b}_{p} {c}_{c} \\ - {b}_{c} {c}_{p} & {A}_{c}\end{matrix} ] , \qquad ( 6 b )$$

$${c}_{g} = [ \begin{matrix}{c}_{p} & 0 & 0\end{matrix} ] ,$$

$${x}_{g} = [ \begin{matrix}- e \\ - \dot{e} \\ {x}_{c}\end{matrix} ] , \qquad ( 6 c )$$

$${x}_{g} ( {t}^{+} ) = [ \begin{matrix}- e ( {t}^{+} ) \\ - \dot{e} ( {t}^{+} ) \\ {x}_{c}^{+}\end{matrix} ] .$$

From the above-described expressions, the initial value response of the closed loop system after the state variable of the feedback controller 502 is reset is described in the Laplace domain, thereby obtaining

$$\begin{matrix}Y ( s ) = {{c}_{g} ( {sI}_{4} - {A}_{g} )}^{- 1} {x}_{g} ( {t}^{+} ) \\ = \frac{{c}_{g} adj ( {sI}_{4} - {A}_{g} ) {x}_{g} ( {t}^{+} )}{det ( {sI}_{4} - {A}_{g} )} \\ = : \frac{{N}_{g} ( s )}{{D}_{g} ( s )} .\end{matrix} \qquad ( 7 )$$

where det(X) is the determinant of a matrix X, and adj(X) is the adjugate matrix of the matrix X. Also, In is an n×n unit matrix.

According to expression (7), the zero of the initial value response of the closed loop system changes depending on the reset value x+c of the state variable of the feedback controller C.

### (Reset Conditions and Reset Time)

To prevent the quadrant glitch from being large based on the request (R2), reset needs to be performed after the time at which the error in the quadrant glitch direction is maximized and before the time at which the reverse quadrant glitch starts. In addition, according to request (R3), the reset conditions needs to be confirmed in real time. Hence, in this example embodiment, if the timing at which the quadrant glitch is maximized is detected in real time, the state variable of the feedback controller C is reset to xc=xc+.

To detect the time at which the quadrant glitch is maximized, the change of the sign of the gradient of the follow-up error is tracked. That is, letting e(iTₛ) be the current follow-up error, and e((i−1)Tₛ) be the follow-up error one sample before, a difference Δe(iTₛ) therebetween is represented by equation (8). The state variable of the feedback controller C is reset when equation (9) is satisfied.

To avoid continuous occurrence of a plurality of times of reset, once reset is performed, reset is inhibited until the target track of the stage causes speed reversal.

$$Δ e ( {iT}_{s} ) = e ( {iT}_{s} ) - e ( ( i - 1 ) {T}_{s} ) \qquad ( 8 )$$

$$Δ e ( {iT}_{s} ) \cdot Δ e ( ( i - 1 ) {T}_{s} ) ≦ 0 \qquad ( 9 )$$

The reset value of the state variable of the feedback controller 502 at the time t=t+ is represented by equation (10) using an actual matrix T, and Tis obtained. If equation (10) is substituted into the numerator of equation (7), we obtain

$${x}_{c}^{+} = T [ \begin{matrix}- e ( {t}^{+} ) \\ - \dot{e} ( {t}^{+} )\end{matrix} ] , T = [ \begin{matrix}{t}_{11} & {t}_{12} \\ {t}_{21} & {t}_{22}\end{matrix} ] \qquad ( 10 )$$

$${N}_{g} ( s ) = [ \begin{matrix}{N}_{g 1} ( s ) & ⋯ & {N}_{g 4} ( s )\end{matrix} ] [ \begin{matrix}{I}_{2} \\ T\end{matrix} ] [ \begin{matrix}- e ( {t}^{+} ) \\ - \dot{e} ( {t}^{+} )\end{matrix} ] \qquad ( 11 )$$

where [N_{g1}(s) . . . N_{g4}(s)] is a 1×4 matrix, and each element is a polynomial of s.

Since, in this example embodiment, the state variable of the feedback controller 502 is reset when the quadrant glitch is maximum, equation (12) holds ideally.

$$e ( {t}^{+} ) = 0 \qquad ( 12 )$$

Hence, if equation (11) is further expanded, the following expression holds

$${N}_{g} ( s ) = ( {N}_{g 1} ( s ) + {t}_{11} {N}_{g 3} ( s ) + {t}_{21} {N}_{g 4} ( s ) ) ( - e ( {t}^{+} ) ) \qquad ( 13 )$$

The zero of the initial value response of the closed loop system is s that satisfies N_{g}(s)=0 in equation (13). Here, −p_{g1}, −p_{g2}, −p_{g3}, and −p_{g4} are defined as the poles of the closed loop, that is, the solution of det(sI₄−A_{g})=0. Furthermore, p_{gΣ}=p_{g1}+p_{g2}+p_{g3}+p_{g4} . . . (14) is defined. At this time, if equation (13) is expanded, and the coefficient of the highest order is set to 1, we obtain

$${N}_{g} ( s ) = {s}^{3} + {p}_{g Σ} {s}^{2} + ( \frac{{RK}_{T}}{J} {t}_{11} + \frac{{RK}_{T}}{J} {t}_{21} + \frac{D ( {Jp}_{g Σ} - D )}{{J}^{2}} ) s + \frac{{RK}_{T} ( {Jp}_{g Σ} - D )}{{J}^{2}} {t}_{11} . \qquad ( 15 )$$

According to equation (15), N_{g}(s)=0 is a cubic equation of s, and the solution (the zero of the initial value response of the closed loop system) is set to −z_{g1}, −z_{g2}, and −z_{g3}. N_{g}(S)=(s+z_{g1}) (S+z_{g2}) (S+z_{g3}) . . . (16)

By comparing the coefficients of the terms of s₂ in equations (15) and (16), the relationship of z_{g3}−p_{g2}−z_{g1}−z_{g2} . . . (17) is obtained for three zeros of the initial value response of the closed loop system. This means that zeros of the initial value response of the closed loop system, which can be arranged by the reset value x+c of the state variable of the feedback controller 502, are only the two zeros (z_{g1} and z_{g2}), and the remaining one zero (z_{g3}) is decided by the poles of the closed loop system and a designated zero.

Furthermore, by comparing the terms of s and the constant terms of equations (15) and(16), the relationship between the two zeros of the initial value response of the closed loop system and t₁₁ and t₂₁ can be obtained by

$$[ \begin{matrix}\frac{{RK}_{T}}{J} & \frac{{RK}_{T}}{J} \\ \frac{{RK}_{T} ( {Jp}_{g Σ} - D )}{{J}^{2}} & 0\end{matrix} ] [ \begin{matrix}{t}_{11} \\ {t}_{21}\end{matrix} ] = [ \begin{matrix}{z}_{g 1} {z}_{g 2} + ( {z}_{g 1} + {z}_{g 2} ) ( {p}_{g Σ} - ( {z}_{g 1} + {z}_{g 2} ) ) - \frac{D ( {Jp}_{g Σ} - D )}{{J}^{2}} \\ {z}_{g 1} {z}_{g 2} ( {p}_{g Σ} - ( {z}_{g 1} + {z}_{g 2} ) )\end{matrix} ] , {Jp}_{g Σ} - D \neq 0. \qquad ( 18 )$$

Hence, t₁₁ and t₂₁, which set the two zeros of the initial value response of the closed loop system to desired values, are obtained by calculating

$$[ \begin{matrix}{t}_{11} \\ {t}_{21}\end{matrix} ] = {[ \begin{matrix}\frac{{RK}_{T}}{J} & \frac{{RK}_{T}}{J} \\ \frac{{RK}_{T} ( {Jp}_{g Σ} - D )}{{J}^{2}} & 0\end{matrix} ]}^{- 1} [ \begin{matrix}{z}_{g 1} {z}_{g 2} + ( {z}_{g 1} + {z}_{g 2} ) ( {p}_{g Σ} - ( {z}_{g 1} + {z}_{g 2} ) ) - \frac{D ( {Jp}_{g Σ} - D )}{{J}^{2}} \\ {z}_{g 1} {z}_{g 2} ( {p}_{g Σ} - ( {z}_{g 1} + {z}_{g 2} ) )\end{matrix} ] , {Jp}_{g Σ} - D \neq 0. \qquad ( 19 )$$

To meet the request (R₂) by resetting the state variable of the feedback controller C, the initial value response (equation (7)) needs to converge into 0 without any overshoot.

A response y (t) of the stable closed loop system G after reset of the state variable will be examined. If τ=t−t+, equation (20) below holds based on the definition of Laplace transformation.

$$Y ( s ) = {\int }_{0}^{∞} y ( τ ) {e}^{- s τ} d τ . \qquad ( 20 )$$

Here, if the zero z of Y(s) is a stable zero later than the pole or an unstable zero, equation (21) below holds.

$${\int }_{0}^{∞} y ( τ ) {e}^{- z τ} d τ = 0 \qquad ( 21 )$$

Since y(τ)=−e(τ), the above-described expression indicates that the weighted time integration of the error is 0, and means that the sign of the error changes midway. That is, if there exists a stable zero later than the pole or an unstable zero, a reverse quadrant glitch is generated. Hence, to suppress overshoot, the zero is arranged at a position earlier than the pole by equation (19).

On the other hand, two zeros can be arranged, and the remaining one zero is automatically decided by the two arranged zeros based on equation (17). Here, all the zeros of the initial value response of the closed loop system are set to the same value to eliminate a late zero, and overshoot is suppressed, thereby suppressing the reverse quadrant glitch.

That is, arranged zeros z_{g1}=z_{g2}=(1/3)·p_{gΣ} is set.

At this time, the remaining zero z_{g3} is set to z_{g3}=(1/3)·p_{gΣ} based on equation (17). Note that how to select the imaginary parts of the arranged zeros z_{g1} and z_{g2} has a degree of freedom, and these are assumed to be real numbers here.

As described above, when the state variable is reset, a reverse quadrant glitch can be suppressed without making the quadrant glitch large. This could be confirmed by simulations and experiments. More specifically, when the state variable is reset, a feedback input changes stepwise, and a reverse quadrant glitch is suppressed by this.

### Third Example Embodiment

A machine tool 700 according to the third example embodiment of the present invention will be described next with reference to FIG. 7. FIG. 7 is a view for explaining the control system of the machine tool 700 according to this example embodiment. The machine tool 700 according to this example embodiment is different from the second example embodiment in that a controller 706 includes an additional input unit 762 in place of the state variable resetter 362. The rest of the components and operations is the same as in the second example embodiment. Hence, the same reference numerals denote the same components and operations, and a detailed description thereof will be omitted.

This example embodiment is particularly effective in a case where the state variable of a feedback controller 361 cannot easily be reset.

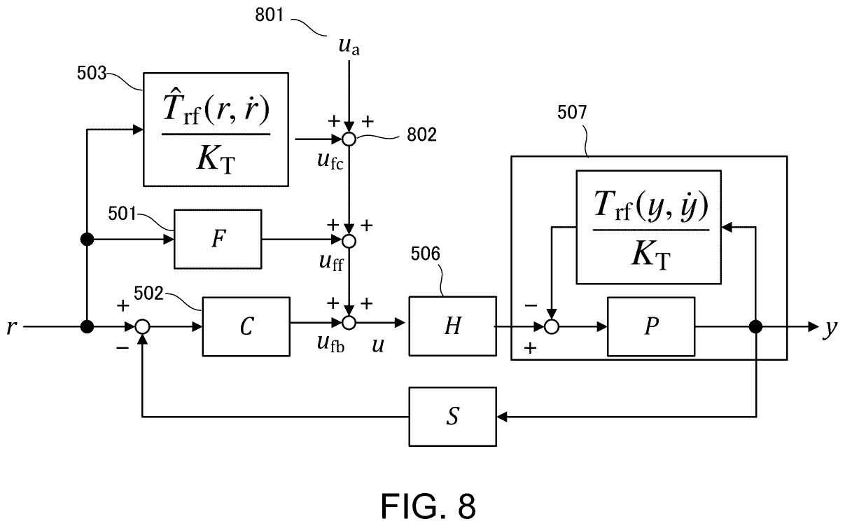

FIG. 8 is a view showing a typical 2-degree-of-freedom control system that performs rolling friction compensation using a friction model according to this example embodiment. An additional input value Ua is added to a friction compensation value Ufc by an adder 802.

The zeros of the initial value response of a closed loop system are reassigned using the additional input value, and the response of the closed loop system is formed.

Here, to derive the response of a feedback controller 502 after the additional input, the following assumptions (B1) to (B3) are made. (B1) In FIG. 8, follow-up performance to a target track r in the absence of a modeling error or a disturbance is guaranteed by a feedforward controller 501. (B2) In FIG. 8, a friction compensation error by a 0th-order hold 506 is regarded as an input end impulse disturbance applied at the time of speed reversal. (B3) Additional input is performed after speed reversal.

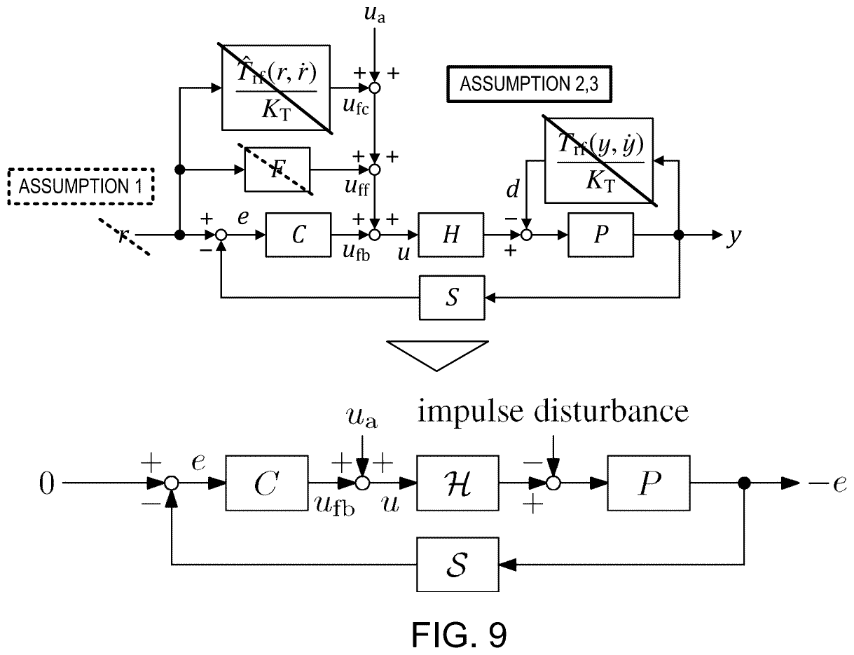

Based on the above-described assumptions, the control system shown in FIG. 8 is examined by simplifying as shown in FIG. 9, and a closed loop system G after additional input is derived as follows.

$$G : \{ \begin{matrix}{x}_{g} ( t ) {A}_{g} {x}_{g} ( t ) + {b}_{g} {u}_{a} ( t ) \\ y ( t ) = - e ( t ) = {c}_{g} {x}_{g} ( t )\end{matrix} , \qquad ( 22 a )$$

$${A}_{g} = [ \begin{matrix}{A}_{p} - {b}_{p} {d}_{c} {c}_{p} & {b}_{p} {c}_{c} \\ - {b}_{c} {c}_{p} & {A}_{c}\end{matrix} ] , {b}_{g} = [ \begin{matrix}{b}_{p} \\ 0 \\ 0\end{matrix} ] , \qquad ( 22 b )$$

$${c}_{g} = [ \begin{matrix}{c}_{p} & 0 & 0\end{matrix} ] , {x}_{g} = [ \begin{matrix}- e \\ - \dot{e} \\ {x}_{c}\end{matrix} ] \qquad ( 22 c )$$

From the above-described expressions, the initial value response of the closed loop system after the additional input is described in the Laplace domain, thereby obtaining

$$Y ( s ) = {{c}_{g} ( {sI}_{4} - {A}_{g} )}^{- 1} {x}_{g} ( {t}^{+} ) + {{c}_{g} ( {sI}_{4} - {A}_{g} )}^{- 1} {b}_{g} {U}_{a} ( s ) , \qquad ( 23 )$$

Here, Y(s)=L {y(t)}, and Uₐ(s)=L {Uₐ(t)}. L { } represents Laplace transformation. t+ is the start timing of additional input, and In is an n×n unit matrix.

### <Timing of Additional Input>

The timing of additional input is the same as the state variable reset timing in the second example embodiment, and is after the time at which the quadrant glitch is maximized and before the time at which the reverse quadrant glitch starts. Hence, in this example embodiment, if the time (equations (8) and (9)) at which the quadrant glitch is maximized is detected in real time, the additional input value is added. That is, the additional input unit 762 adds the additional input value to command data 321 within a predetermined time after speed reversal of a moving body 201. More specifically, the additional input value is added to the command data 321 at a timing at which the follow-up error in the quadrant glitch direction by feed drivers 202 to 207 is maximized.

### <Magnitude of Additional Input Value>

Also, when obtaining the magnitude of the additional input value Uₐ(s), T is obtained by setting Yᵣ(s)=Yₐ(s) in equation (11) of the second example embodiment. In this example embodiment, [N_{g1}(s) . . . N_{g4}(s)] is a 1×4 matrix, and the elements are represented by

$$Ng 1 ( s ) = {s}^{3} + {p}_{g Σ} {s}^{2} + \frac{D}{J} ( {p}_{g Σ} - \frac{D}{J} ) s , \qquad ( 24 a )$$

$$Ng 2 ( s ) = {s}^{2} + ( {p}_{g Σ} - \frac{D}{J} ) s , \qquad ( 24 b )$$

$$Ng 3 ( s ) = \frac{{RK}_{T}}{J} \{ s + ( {p}_{g Σ} - \frac{D}{J} ) \} , \qquad ( 24 c )$$

$$Ng 4 ( s ) = \frac{{RK}_{T}}{J} s . \qquad ( 24 d )$$

If equations (24) and e·(t+)=0 are substituted into equation (11), N_{g}(s) can be obtained as follows.

$$Ng ( s ) = {s}^{3} + {p}_{g Σ} {s}^{2} + \{ \frac{{RK}_{T}}{J} {t}_{11} + \frac{{RK}_{T}}{J} {t}_{21} + \frac{D}{J} ( {p}_{g Σ} - \frac{D}{J} ) \} s + \frac{{RK}_{T}}{J} ( {p}_{g Σ} - \frac{D}{J} ) {t}_{11} . \qquad ( 25 )$$

Here, the coefficient is normalized such that the coefficient of the term of the highest order is 1.

According to the above-described expression, the response Yr(s) includes three zeros −z_{g1}, −z_{g2}, and −z_{g3} that satisfy N_{g}(s)=(s+z_{g1}) (s+z_{g2}) (S+z_{g3}).

If the coefficients of the above expression are compared, we obtain z_{g1}+

$${z}_{g 2} + {z}_{g 3} = {p}_{g Σ} [ \begin{matrix}\frac{{RK}_{T}}{J} & \frac{{RK}_{T}}{J} \\ \frac{{RK}_{T}}{{J}^{2}} ( {p}_{g Σ} - \frac{D}{J} ) & 0\end{matrix} ] [ \begin{matrix}{t}_{11} \\ {t}_{21}\end{matrix} ] = [ \begin{matrix}{z}_{g 1} {z}_{g 2} + {z}_{g 2} {z}_{g 3} + {z}_{g 3} {z}_{g 1} - \frac{D}{J} ( {p}_{g Σ} - \frac{D}{J} ) \\ {z}_{g 1} {z}_{g 2} {z}_{g 3}\end{matrix} ] . \qquad ( 26 )$$

When the above expression is solved, we can obtain gains t₁₁ and t₂₁, which implement desired zeros. However, the above-described zeros have constraints. The reverse quadrant glitch is not generated if the response Y converges into 0 without overshoot. Overshoot is caused by a late zero. Hence, in this example embodiment, all zeros of the response Yᵣ(s) are set to the same value as follows.

$${z}_{g 1} = {z}_{g 2} = {z}_{g 3} = ( {p}_{g Σ} ) / 3 \qquad ( 27 )$$

Equation (27) is substituted into equation (26), thereby obtaining the gains t₁₁ and t₂₁.

When Yᵣ(s)=Yₐ(s) is solved, the additional input value Uₐ(s) is represented by

$${U}_{a} ( s ) = \frac{{x}_{c 1}^{+} - {x}_{c 1} ( {t}^{+} )}{s} + {F}_{a 2} \frac{{x}_{c 2}^{+} - {x}_{c 2} ( {t}^{+} )}{s} , \qquad ( 28 a )$$

$${F}_{a 2} ( s ) = \frac{s}{s + ( {p}_{g Σ} - \frac{D}{J} )} . \qquad ( 28 b )$$

To calculate the additional input value, the state variable of the feedback controller 502 is used. The additional input value can be calculated by simulating the state variable in real time.

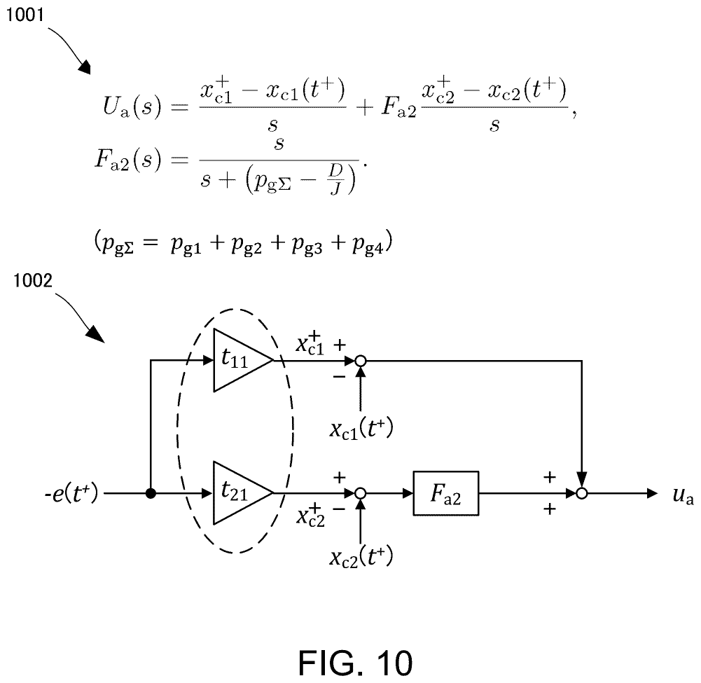

FIG. 10 shows calculation expressions 1001 and a calculation block diagram 1002 of the additional input value. Thus, to reduce a reverse response that occurs due to addition of the friction compensation value, the additional input unit 762 adds, to a command value, an additional input value equivalent to reset of the state variable of the feedback controller 361. That is, the additional input unit 762 calculates an additional input value that makes all the zeros of the initial value response of the feedback controller 361 equal.

Note that in this example embodiment, a ball screw has been described as an example of a feed driver. However, the present invention is not limited to this. Also, in the above-described example embodiments, a friction compensation value calculated using a rolling friction model is added to a current value. However, the present invention is not limited to this, and a friction compensation value obtained from measurement data of rolling friction may be added to a current value.

Furthermore, a machine tool control apparatus including a friction compensator and a reverse response reducer to implement the above-described control in a machine tool is also incorporated in the present invention.

### Other Example Embodiments

While the invention has been particularly shown and described with reference to example embodiments thereof, the invention is not limited to these example embodiments. It will be understood by those of ordinary skill in the art that various changes in form and details may be made therein without departing from the spirit and scope of the present invention as defined by the claims. A system or apparatus including any combination of the individual features included in the respective example embodiments may be incorporated in the scope of the present invention.

The present invention is applicable to a system including a plurality of devices or a single apparatus. The present invention is also applicable even when an information processing program for implementing the functions of example embodiments is supplied to the system or apparatus directly or from a remote site. Hence, the present invention also incorporates the program installed in a computer to implement the functions of the present invention by the computer, a medium storing the program, and a WWW (World Wide Web) server that causes a user to download the program. Especially, the present invention incorporates at least a non-transitory computer readable medium storing a program that causes a computer to execute processing steps included in the above-described example embodiments.

This application is based upon and claims the benefit of priority from Japanese patent application No. 2022-011321, filed on Jan. 27, 2022, the disclosure of which is incorporated herein in its entirety by reference.

1. A machine tool comprising:
a feed driver that moves a moving body in the machine tool;
a feedback controller that feedback-controls said feed driver in accordance with a state variable;
a friction compensator that, to compensate for rolling friction that occurs in said feed driver, adds, in advance, one of a friction compensation value obtained from measurement data of rolling friction and a friction compensation value calculated using a rolling friction model to a command value to be input to said feed driver; and
a reverse response reducer that reduces, using the state variable of said feedback controller, a reverse response that occurs due to addition of the friction compensation value.

2. The machine tool according to claim 1, wherein said reverse response reducer is
an additional input unit that, to reduce the reverse response that occurs due to addition of the friction compensation value, adds an additional input value equivalent to reset of the state variable of said feedback controller to the command value.

3. The machine tool according to claim 2, wherein said additional input unit adds the additional input value to the command value within a predetermined time after speed reversal of the moving body.

4. The machine tool according to claim 3, wherein said additional input unit
adds the additional input value to the command value at a timing at which a follow-up error in a quadrant glitch direction by said feed driver is maximized.

5. The machine tool according to claim 2, wherein said additional input unit
calculates the additional input value that makes all zeros of an initial value response of said feedback controller equal.

6. The machine tool according to claim 1, wherein said reverse response reducer is
a state variable resetter that, to reduce the reverse response that occurs due to addition of the friction compensation value, performs initial value compensation of resetting the state variable of said feedback controller.

7. The machine tool according to claim 6, wherein said state variable resetter resets the state variable within a predetermined time after speed reversal of the moving body.

8. The machine tool according to claim 7, wherein said state variable resetter
resets the state variable in real time at a timing at which an error in a quadrant glitch direction by said feed driver is maximized.

9. The machine tool according to claim 6, wherein said state variable resetter
resets the state variable such that all zeros of an initial value response of said feedback controller equal.

10. A machine tool control system comprising:
a feedback controller that feedback-controls, in accordance with a state variable, a feed driver that moves a moving body in a machine tool;
a friction compensator that, to compensate for rolling friction that occurs in the feed driver, adds, in advance, one of a friction compensation value obtained from measurement data of rolling friction and a friction compensation value calculated using a rolling friction model to a command value to be input to the feed driver; and
a reverse response reducer that reduces, using the state variable of said feedback controller, a reverse response that occurs due to addition of the friction compensation value.

11. A machine tool control method comprising:
feedback-controlling, in accordance with a state variable, a feed driver that moves a moving body in a machine tool;
to compensate for rolling friction that occurs in the feed driver, adding, in advance, one of a friction compensation value obtained from measurement data of rolling friction and a friction compensation value calculated using a rolling friction model to a command value to be input to the feed driver; and
reducing, using the state variable in the feedback-controlling, a reverse response that occurs due to addition of the friction compensation value.
